(19) United States
(12) Patent Application Publication
(10) Pub. No.: US 2010/0277738 A1
(43) Pub. Date: Nov. 4, 2010

(54) Visualized plasmon resonance biodetector

(76) Inventors: Ta-Jen Yen, Hsinchu County (TW); Hsin-Yun Chang, Taichung City (TW); Chung-Tien Li, Tainan County (TW)

Correspondence Address: Muncy, Geissler, Olds & Lowe, PLLC, 4000 Legato Road, Suite 310, FAIRFAX, VA, 22033, US

(21) Appl. No.: 12/387,336

(22) Filed: Apr. 30, 2009

(51) Int. Cl. G01N 21/55

(52) U.S. Cl. 356/445

(57) ABSTRACT

The present invention discloses a visualized plasmon resonance biodetector, which utilizes the surface plasmon resonance to detect a plurality of biochemical molecules, and which comprises a substrate, a silver-gold dual-layer structure, and a visible light source. The silver-gold dual-layer structure is formed on the substrate. In a test, a biochemical molecule combines with the silver-gold dual-layer structure, and the visible light source emits a visible light to illuminate the substrate. Thus, the silver-gold dual-layer structure on the substrate generates surface plasmon resonance and a reflected light. The user can use his naked eyes to discriminate the reflected lights and learn the component and concentration of the biochemical molecule. Therefore, the present invention can provide a low-cost and easy-to-operate detection instrument for biotests.

### FIELD OF THE INVENTION

The present invention relates to a biodetector, particularly to a visualized plasmon resonance biodetector.

### BACKGROUND OF THE INVENTION

In the conventional surface plasmon resonance detector, a probe is connected to a gold-coated glass. When a specimen passes through the detector, the surface refractivity and the resonant angle are changed if the specimen contains a material able to combine with the probe. The variation of the resonant angle thus determines whether there is a material able to combine with the probe in the specimen. Further, the value of the resonant angle variation correlates with the quantity of the material combining with the probe. Therefore, the plasmon resonance detector can also be used in quantitative analysis. The plasmon resonance technology can undertake instant and successive tests without labeling the specimens. The reason why gold is coated on glass is that low surface activity of gold implies high biocompatibility. Further, when gold nanoparticles are used in the plasmon resonance technology, the frequency of surface plasmon resonance varies with the fabrication technology. Thus, the plasmon resonance detector can present different visible colors and extensively apply to biotests.

The surface plasmon resonance technology has very high resolution. However, it needs a high optical precision spectrometer and a high mechanical precision angle analyzer. Therefore, only research organizations or medical laboratories/manufacturers can afford it. The common hospitals and clinics are hard to use the expensive technology but still use the PCR (Polymerase Chain Reaction)-based technologies now, including PCR, RT-PCR (Reverse Transcription PCR), electrophoresis, and gene sequencing. The PCR-based technologies are cheaper and highly sensitive. However, the operation procedures thereof are so complicated that common personnel cannot undertake the PCR-based tests, and only the fully-trained personnel can correctly undertake the PCR-based tests. Sometimes, the protein of the gene of a specimen is hard to duplicate. Thus, the PCR-based technologies cannot detect the protein of a very low concentration at a high sensitivity.

### SUMMARY OF THE INVENTION

One objective of the present invention is to provide a high-precision and easy-to-operate visualized plasmon resonance biodetector.

To achieve the abovementioned objective, the present invention proposes a visualized plasmon resonance biodetector, which utilizes the surface plasmon resonance to detect a plurality of biochemical molecules, and which comprises a substrate, a silver-gold dual-layer structure, and a visible light source. The silver-gold dual-layer structure is formed on the substrate and able to combine with a biochemical molecule. The visible light source emits a visible light to illuminate the substrate, whereby the silver-gold dual-layer structure creates surface plasmon resonance and generates a reflected light.

Via the abovementioned technical scheme, the visualized plasmon resonance biodetector of the present invention has the following advantages:

1. In the present invention, the visible light source adopts a white light source with wavelengths ranging from 400 to 750 nm, and the white light source may be realized with a common white light LED (Light Emitting Diode). The present invention needn't use any special optical energy detector. Therefore, the present invention is a low-cost and easy-to-operate detector for common hospitals and clinics.

2. As the surface of conventional gold nanoparticles can combine with the ligands and the thio groups by weak bonding, the surface of gold nanoparticles is easy to modify. The surface plasmon band of silver can absorb photons with wavelengths ranging from 390 to 400 nm, and silver has an absorption coefficient four times higher than that of gold. Thus silver is an ideal material for biotest. The present invention integrates the advantages of gold and silver to promote the sensitivity of the biodetector.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram showing the curves of the test results, wherein the visualized plasmon resonance biodetector according to the present invention adopts a 35 nm silver film and a 5 nm gold film to test a first group of solutions;

FIG. 2 is a diagram showing the reflected lights in the test, wherein the visualized plasmon resonance biodetector according to the present invention adopts a 35 nm silver film and a 5 nm gold film to test the first group of solutions;

FIG. 3 is a diagram showing the curves of the test results, wherein the visualized plasmon resonance biodetector according to the present invention adopts a 35 nm silver film and a 5 nm gold film to test a second group of solutions;

FIG. 4 is a diagram showing the reflected lights in the test, wherein the visualized plasmon resonance biodetector according to the present invention adopts a 35 nm silver film and a 5 nm gold film to test the second group of solutions; and

FIG. 5 is a diagram showing the test results, wherein the visualized plasmon resonance biodetector according to the present invention adopts a 35 nm silver film and a 5 nm gold film to perform another biotest.

### DETAILED DESCRIPTION OF THE PREFERRED EMBODIMENTS

Below, the technical contents of the present invention are described in detail in cooperation with the embodiments. However, it should be understood that the embodiments are only to exemplify the present invention but not to limit the scope of the present invention.

The present invention proposes a visualized plasmon resonance biodetector, which utilizes the surface plasmon resonance to detect a plurality of biochemical molecules, and which comprises a substrate, a silver-gold dual-layer structure, and a visible light source. The substrate is made of a glass. A silver film and a gold film are sequentially deposited on the substrate with an electron-gun vapor deposition method to form the silver-gold dual-layer structure. A titanium film is pre-coated between the substrate and the silver-gold dual-layer structure to enhance the adhesion of the silver-gold dual-layer structure and enable the repeated use of the present invention. The visible light source emits a visible light to illuminate the substrate. The visible light source may be a white light source with wavelengths ranging from 400 to 750 nm. The visible light can react with the silver-gold dual-layer structure to create a reflected light for inspection.

The reason why the present invention adopts the gold film or the conventional biotest technologies adopt gold nanoparticles is that the surface of gold nanoparticles can combine with the ligands and the thio groups by weak bonding, and the surface of gold nanoparticles is thus easy to modify. Then, the functional groups at the ends of biochemical molecules can combine with gold nanoparticles. Therefore, gold nanoparticles have low surface activity and high biocompatibility. Further, when gold nanoparticles apply to the surface plasmon resonance technology, they can present different colors. Besides, the diameter of gold nanoparticle is easy to control and ranges from few to 100 nm. Due to the abovementioned characteristics, gold nanoparticles are extensively used in biotest technologies.

The silver nanoparticles in the silver film have two characteristics: (1) the surface plasmon band of silver nanoparticles can absorb photons with wavelengths ranging from 390 to 400 nm; and (2) silver nanoparticles have an absorption coefficient four times higher than that of gold nanoparticles.

In the present invention, the silver-gold dual-layer structure is formed on the substrate via an electron-gun vapor deposition method. The present invention employs the biocompatibility and the color response in plasmon resonance of the gold film and the surface plasmon resonance feature of the silver film to construct the high-biosensitivity and high-precision biodetector. Before forming the silver-gold dual-layer structure, the present invention pre-coats a titanium film on the substrate to overcome the irreversibility problem of gold nanoparticles, improve the adhesion of the gold film and enable the repeated use of the biodetector.

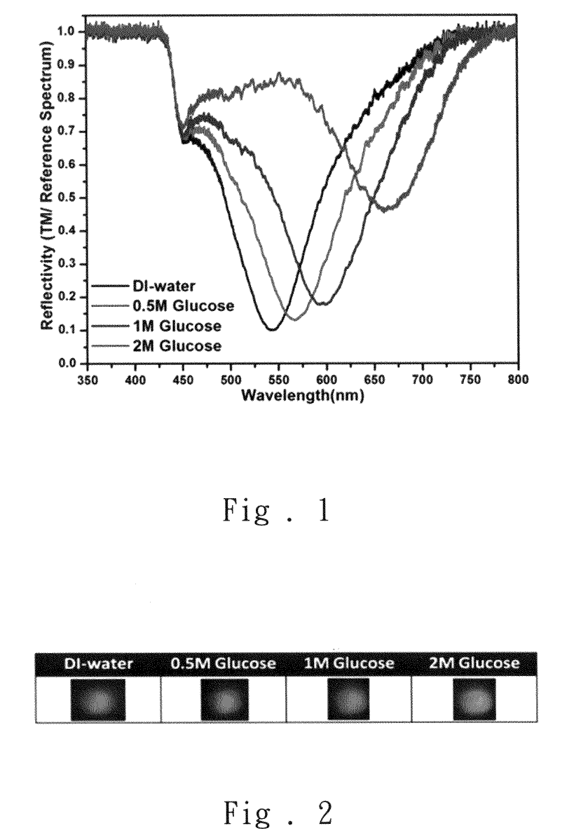

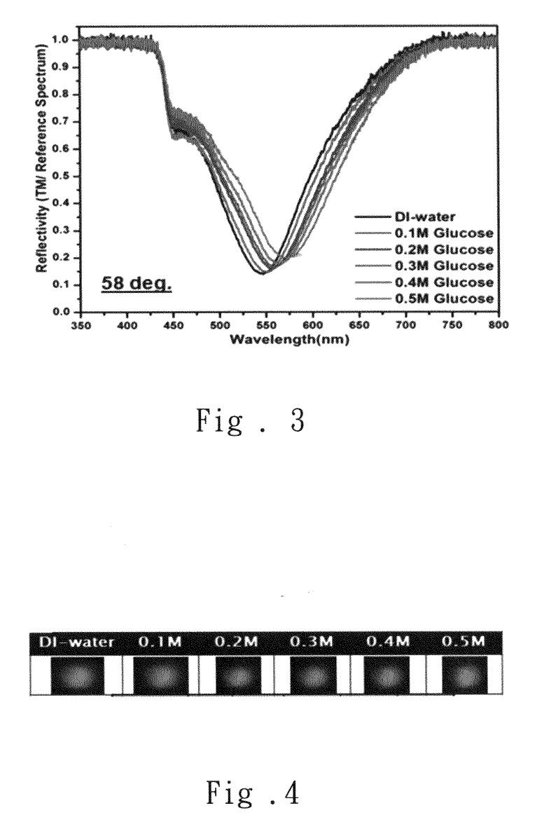

Refer FIG. 1 and FIG. 2 for the results of tests using the present invention, wherein the present invention adopts a 35 nm silver film and a 5 nm gold film to test a first group of solutions containing DI (deionized) water, 0.5M, 1M and 2M glucose solutions. In FIG. 1, the visible light is absorbed by the silver-gold dual-layer structure, and different V-shape curves are detected for different concentrations of solutions. In FIG. 2, the wavelengths of the reflected lights are within the visible-light spectrum ranging from 400 to 750 nm and present different colors for different concentrations of solutions. Refer to FIG. 3 and FIG. 4 for the results of tests using the present invention, wherein the present invention adopts a 35 nm silver film and a 5 nm gold film to test a second group of solutions containing DI (deionized) water, 0.1M, 0.2M, 0.3M, 0.4M and 0.5M glucose solutions. It is known from FIG. 3 and FIG. 4 that even smaller concentration difference can also be discriminated by the present invention.

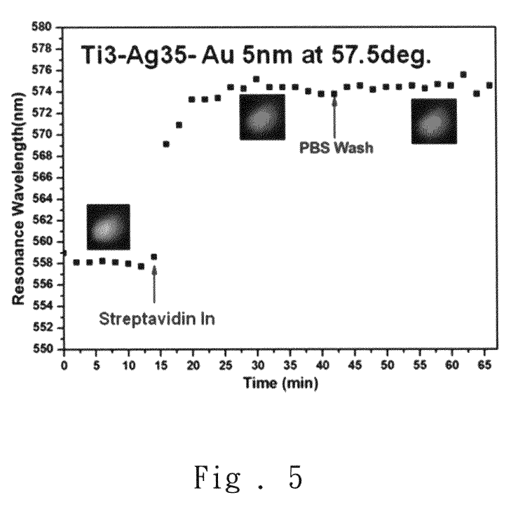

Refer to FIG. 5 for the results of tests using the present invention, wherein the present invention adopts a 35 nm silver film and a 5 nm gold film to test the specific binding reaction between biotin and streptavidin. It proves that the present invention can create a binding condition for the silver-gold dual-layer structure and another biochemical molecule to implement another biotest.

In conclusion, the present invention uses the design integrating the silver-gold dual-layer structure and the visible light source to undertake biotests and present results visible for human eyes. The present invention can discriminate very small difference of concentrations. The present invention can create a binding condition for the silver-gold dual-layer structure and a different biochemical molecule to implement a different biotest. The present invention needn't use a special optical detector to analyze the detection outputs but can use the surface plasmon resonance to achieve high-precision detection. Therefore, the present invention can provide a low-cost and easy-to-operate detection instrument for common hospitals and clinics. In the present invention, the silver film having a high absorption coefficient cooperates with the gold film to promote the sensitivity of the biodetector. Further, the present invention uses a titanium layer to enhance the adhesion of the gold film and enable the repeated use of the biodetector, whereby the cost of biotests is reduced.

What is claimed is:

1. A visualized plasmon resonance biodetector, which utilizes surface plasmon resonance to detect a plurality of biochemical molecules,
comprising
a substrate;
a silver-gold dual-layer structure formed on said substrate; and
a visible light source emitting a visible light to illuminate said substrate and react with said silver-gold dual-layer structure to generate a reflected light.

2. The visualized plasmon resonance biodetector according to claim 1, wherein said substrate is made of a glass.

3. The visualized plasmon resonance biodetector according to claim 1, wherein a silver film and a gold film are sequentially deposited on said substrate with an electron-gun vapor deposition method to form said silver-gold dual-layer structure.

4. The visualized plasmon resonance biodetector according to claim 3, wherein a titanium film is pre-coated between said substrate and said silver-gold dual-layer structure.

5. The visualized plasmon resonance biodetector according to claim 1, wherein said visible light source is a white light source having wavelengths ranging from 400 to 750 nm.
